(19) United States
(12) Patent Application Publication
(10) Pub. No.: US 2022/0283271 A1
(43) Pub. Date: Sep. 8, 2022

(54) BEAM SCANNING SYSTEM FOR LIDAR

(71) Applicant: DENSELIGHT SEMICONDUCTORS PTE LTD, Singapore (SG)

(72) Inventors: Long Cheng Koh, Singapore (SG); Yee Loy Lam, Singapore (SG)

(21) Appl. No.: 17/653,044

(22) Filed: Mar. 1, 2022

Related U.S. Application Data
(60) Provisional application No. 63/155,498, filed on Mar. 2, 2021.

(51) Int. Cl. G01S 7/481

(52) U.S. Cl. CPC G01S 7/4814; G01S 7/4817

(57) ABSTRACT

A beam scanning system includes a light source, an optical switch, a set of spectral dispersive elements, and a set of contour dispersive arrays. The light source emits a beam of light that is received by at least one of the optical switch or a spectral dispersive element. The optical switch emits the received beam of light from an output port that is selected based on a control signal. The spectral dispersive element receives the beam of light from the optical switch. The spectral dispersive element disperses the beam of light to scan a desired target area. One of the contour dispersive arrays receives the dispersed beam of light from the spectral dispersive array and refracts the dispersed beam of light into an array of light beams that scan a desired target area.

### CROSS-REFERENCE TO RELATED APPLICATIONS/INCORPORATION BY REFERENCE

This Patent Application makes reference to, claims priority to, and claims the benefit of U.S. provisional application 63/155,498 filed Mar. 2, 2021, the contents of which is hereby incorporated herein by reference in its entirety.

### FIELD

Various embodiments of the disclosure relate generally to optoelectronic devices. More particularly, various embodiments of the present disclosure relate to a beam scanning system for Light Detection and Ranging (LIDAR) based systems.

### BACKGROUND

LIDAR systems are utilized to detect an object by way of light in a desired area. The object may be a vehicle, a building, landforms, or the like. A LIDAR system typically includes a beam scanner to scan the desired area to detect the object.

Some LIDAR systems implement beam scanners using mechanical components. In one example, a gimbal is utilized to manipulate a beam of a light source to scan a desired area. In another example, scanning mirrors are utilized in the beam scanners. However, utilization of such mechanical components is susceptible to reliability issues and vibration effects in the components that are undesirable.

Other LIDAR systems implement beam scanners using solid-state solutions that are free of moving parts. Current solid-state solutions utilize an optical phase array (OPA) as beam scanners. The OPA includes a light source, a power splitter, an array of phase shifters, and an array of nanophotonic antenna elements. The power splitter splits an input light emitted from the light source into an array of light beams that are received by the array of phase shifters. By controlling a phase delay of each phase shifter, phase delayed light beams are provided to the array of nanophotonic antenna elements from the array of phase shifters. The array of nanophotonic antenna elements emits an array of light beams to scan a desired target area. However, as such solid-state solutions include a power splitter, a high-power light source is essential thereby resulting in high optical loss from the OPA.

Limitations and disadvantages of conventional approaches will become apparent to one of skill in the art, through comparison of described systems with some aspects of the present disclosure, as outlined in the remainder of the present application and with reference to the drawings.

### SUMMARY

A beam scanning system is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

The accompanying drawings illustrate various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements, and in which:

FIG. 1 is a diagram that illustrates a beam scanning system, in accordance with an embodiment of the present disclosure;

FIG. 2 is a diagram that illustrates a first contour dispersive element of a first plurality of contour dispersive elements of the beam scanning system of FIG. 1, in accordance with an embodiment of the present disclosure;

FIG. 3 is a diagram that illustrates a schematic view of a dispersion of a beam of light by a spectral dispersive element and emission of a first array of light beams by a first contour dispersive array of the beam scanning system of FIG. 1 to scan a desired target area, in accordance with an embodiment of the present disclosure;

FIG. 4 is a diagram that illustrates a schematic view of the first contour dispersive element of FIG. 3 and a first contoured surface, in accordance with an embodiment of the present disclosure;

FIG. 5 is a diagram that illustrates a schematic view of a raster scan pattern and a clock-wise spiral scan pattern formed by scanning the desired target area by the beam scanning system of FIG. 1, in accordance with an embodiment of the present disclosure;

FIG. 6 is a diagram that illustrates a schematic view of the desired target area of FIG. 3, in accordance with an embodiment of the present disclosure.

FIG. 7 is a diagram that illustrates a schematic view of another beam scanning system, in accordance with another embodiment of the present disclosure;

FIG. 8 is a diagram that illustrates a schematic view of another beam scanning system in accordance with yet another embodiment of the present disclosure; and

FIGS. 9A, 9B, and 9C is a flowchart that collectively illustrates a beam scanning method of the beam scanning system of FIG. 1, in accordance with an embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed description given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

In an embodiment, a beam scanning system may be provided. The beam scanning system comprises a light source, an optical switch, a spectral dispersive array, and a plurality of contour dispersive arrays. The light source may be configured to emit a beam of light. The optical switch may be coupled to the light source and have a plurality of output ports. The optical switch may be configured to receive the beam of light, direct the beam of light to a first output port of the plurality of output ports, and emit the beam of light from the corresponding output port. The spectral dispersive array comprises a plurality of spectral dispersive elements. Each spectral dispersive element of the plurality of spectral dispersive elements may be coupled to a corresponding output port of the plurality of output ports. A first spectral dispersive element of the plurality of spectral dispersive elements may be configured to receive the beam of light from the first output port of the optical switch and disperse the beam of light into a plurality of wavelength sub-bands of light.

In some embodiments, each contour dispersive array of the plurality of contour dispersive arrays may be associated with a corresponding spectral dispersive element of the spectral dispersive array. A first contour dispersive array of the plurality of contour dispersive arrays comprises a plurality of contour dispersive elements. Each contour dispersive element of the plurality of contour dispersive elements may be configured to receive and refract a corresponding wavelength sub-band of light of the plurality of wavelength sub-bands of light such that the first contour dispersive array emits an array of light beams to scan a desired target area.

In some embodiments, the light source may be a wavelength-tunable light source.

In some embodiments, the optical switch may be further configured to receive a control signal and select the first output port to output the beam of light based on the control signal.

In some embodiments, the beam of light emitted by the light source may be a full wavelength spectrum.

In some embodiments, a number of output ports in the optical switch may be equal to a number of spectral dispersive elements in the spectral dispersive array and a number of contour dispersive arrays of the plurality of contour dispersive arrays.

In some embodiments, a number of wavelength sub-bands of light may be equal to a number of contour dispersive elements in a contour dispersive array of the plurality of contour dispersive arrays.

In some embodiments, each contour dispersive element of the plurality of contour dispersive elements comprises a plurality of contours such that each contour of the plurality of contours has a corresponding yaw angle and a corresponding pitch angle.

In some embodiments, each contour of the plurality of contours provides a corresponding angle of refraction to the received wavelength sub-band of light simultaneously such that each contour dispersive element of the plurality of contour dispersive elements simultaneously emits a corresponding plurality of refracted beams of light. The array of light beams includes the corresponding plurality of refracted beams of light emitted from each contour dispersive element.

In some embodiments, the plurality of wavelength sub-bands of light are contiguous wavelength sub-bands of light.

In some embodiments, the beam of light may be dispersed based on an optical path distance between the spectral dispersive array and the plurality of contour dispersive arrays.

In some embodiments, the optical switch may be a free space optical switch, a fiber optic switch, a silicon-photonics based optical switch, and a group III-V based optical switch. The optical switch may further include a gain element.

In another embodiment, a beam scanning system may be provided. The beam scanning system comprises a light source, a spectral dispersive element, and a contour dispersive array. The light source may be configured to emit a beam of light. The optical switch may be configured to receive the beam of light, direct the beam of light to a first output port of the plurality of output ports, and emit the beam of light from the corresponding output port. The spectral dispersive element may be configured to receive the beam of light and disperse the beam of light into a plurality of wavelength sub-bands of light. The contour dispersive array comprises a plurality of contour dispersive elements. Each contour dispersive element of the plurality of contour dispersive elements may be configured to receive and refract a corresponding wavelength sub-band of light of the plurality of wavelength sub-bands of light such that the contour dispersive array emits an array of light beams to scan a desired target area.

In yet another embodiment, a beam scanning system may be provided. The beam scanning system comprises a light source, an optical switch, and a spectral dispersive array. The light source may be configured to emit a beam of light. The optical switch may be coupled to the light source and have a plurality of output ports. The optical switch may be configured to receive the beam of light, direct the beam of light to a first output port of the plurality of output ports, and emit the beam of light from the corresponding output port. The spectral dispersive array comprises a plurality of spectral dispersive elements. Each spectral dispersive element of the plurality of spectral dispersive elements may be coupled to a corresponding output port of the plurality of output ports. A first spectral dispersive element of the plurality of spectral dispersive elements may be configured to receive the beam of light from the first output port of the optical switch and disperse the beam of light into a plurality of wavelength sub-bands of light to scan a desired target area.

Various embodiments of the present disclosure disclose a beam scanning system. The beam scanning system includes a light source, an optical switch, a spectral dispersive array, and contour dispersive arrays. The light source emits a beam of light that is received by the optical switch. The optical switch has various output ports and emits the received beam of light through one of the output ports based on a control signal. The spectral dispersive array includes spectral dispersive elements. One of the spectral dispersive elements receives the beam of light emitted from the output port of the optical switch and disperses the beam of light into wavelength sub-bands of light. One of the contour dispersive arrays receives the wavelength sub-bands of light and refracts the received wavelength sub-bands of light. The refracted wavelength sub-bands of light form an array of light beams that is utilized to scan a desired target area. The beam scanning system of the present disclosure is a solid-state system that is free of moving parts and hence is not susceptible to reliability issues and vibration effects in comparison to conventional beam scanning systems realized using mechanical components. Further, in comparison to conventional solid-state beam scanning systems that utilize a high-power light source, the beam scanning system of the present disclosure utilizes a low power light source thereby resulting in a low optical loss.

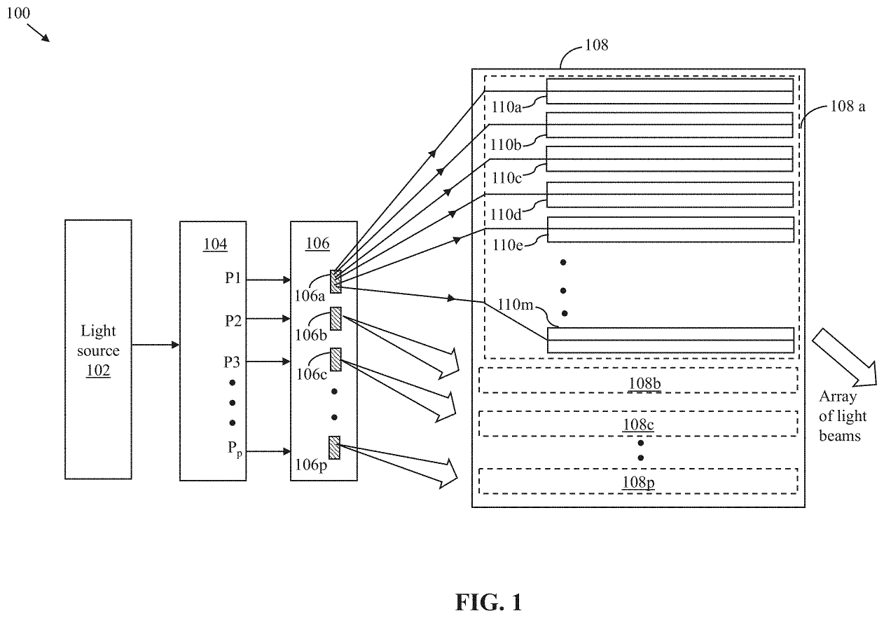

FIG. 1 is a diagram that illustrates a beam scanning system 100, in accordance with an embodiment of the present disclosure. The beam scanning system 100 may include a light source 102, an optical switch 104, a spectral dispersive array 106, and a plurality of contour dispersive arrays 108.

The light source 102 may be configured to emit a beam of light. The light source 102 may be a wavelength-tunable light source. The beam of light emitted by the light source 102 is a full wavelength spectrum of light. The full wavelength spectrum of light refers to a range of light from infrared to near-ultraviolet of the electromagnetic spectrum. The beam of light emitted by the light source 102 may be provided to the optical switch 104. Examples of the light source 102 may include a laser, a light-emitting diode, a superluminescent light-emitting diode, or the like.

The optical switch 104 may be coupled to the light source 102. The optical switch 104 may be configured to receive the beam of light from the light source 102. The optical switch 104 has a plurality of output ports P1-Pp of which a first output port P1, a second output port P2, a third output port P3, . . . , and a p^{th} output port Pp are shown. Each output port of the plurality of output ports P1-Pp may be spatially separated in a regular pitch. The optical switch 104 may be further configured to receive a control signal from an external controller (not shown) and select an output port from the plurality of output ports P1-Pp based on the received control signal. The optical switch 104 may be further configured to direct the received beam of light from the light source 102 to the selected output port and emit the beam of light from the selected output port of the plurality of output ports P1-Pp. At a single time instance, the optical switch 104 may be configured to emit the beam of light from a single output port of the plurality of output ports P1-Pp.

The optical switch 104 may further include a gain element to amplify power of the beam of light. The optical switch 104 may be further configured to provide the emitted beam of light from the selected output port to the spectral dispersive array 106. Examples of the optical switch 104 may include, but are not limited to, a free-space optical switch, a fiber optic switch, a silicon-photonics based optical switch, and a group III-V based optical switch. In an embodiment, when the optical switch 104 may be a silicon-photonics based switch, the light source 102 and the optical switch 104 may be integrated into a single element by monolithic integration, hybrid integration, bulk coupling, or by free-space optics coupling.

The spectral dispersive array 106 may be coupled to the optical switch 104. The spectral dispersive array 106 may be configured to receive the beam of light from the corresponding output port of the optical switch 104. The spectral dispersive array 106 comprises a plurality of spectral dispersive elements 106a-106p of which a first spectral dispersive element 106a, a second spectral dispersive element 106b, a third spectral dispersive element 106c, . . . , and a p^{th} spectral dispersive element 106p are shown. Each spectral dispersive element of the plurality of spectral dispersive elements 106a-106p is parallelly connected to a corresponding output port of the plurality of output ports P1-Pp. In an exemplary scenario, the first spectral dispersive element 106a may be parallelly connected to the first output port P1. Further, the first spectral dispersive element 106a may be configured to receive the beam of light from the first output port P1. The first spectral dispersive element 106a may be further configured to refract different wavelengths present in the beam of light (i.e., the full wavelength spectrum of light) at different angles which results in the dispersion of the beam of light into a first plurality of wavelength sub-bands of light. Each wavelength sub-band of light of the first plurality of wavelength sub-bands of light refers to a corresponding wavelength of light such that the first plurality of wavelength sub-bands of light are contiguous wavelength sub-bands of light. The first plurality of wavelength sub-bands of light include a first wavelength sub-band of light, a second wavelength sub-band of light, a third wavelength sub-band of light, a fourth wavelength sub-band of light, a fifth wavelength sub-band of light up to an m^{th} wavelength sub-band of light.

The dispersion of the beam of light is due to differences in refractive indices of an interface between two optical transmissive materials. In an example, the two optical transmissive materials are air and glass. Further, each element of the plurality of spectral dispersive elements 106a-106p is an optical glass. It is known to a person skilled in the art that a refractive index of a material is inversely proportional to a wavelength of light passing through the material. Thus, the beam of light received by the first spectral dispersive element 106a is dispersed into the first plurality of wavelength sub-bands of light. Other examples of the first spectral dispersive element 106a may include a prism, a diffractive optical element, or the like.

The second spectral dispersive element 106b, the third spectral dispersive element 106c up to the p^{th} spectral dispersive element 106p may be configured to receive the beam of light from the second output port P2, the third output port P3 up to the p^{th} output port Pp, respectively. Further, the second spectral dispersive element 106b, the third spectral dispersive element 106c up to the p^{th} spectral dispersive element 106p are structurally and functionally similar to the first spectral dispersive element 106a. In one embodiment, at one time instance, only one spectral dispersive element of the plurality of spectral dispersive elements 106a-106p may be configured to receive the beam of light from the corresponding output port of the plurality of output ports P1-Pp of the optical switch 104. In another embodiment, more than one output port may provide the beam of light to corresponding spectral dispersive elements of the plurality of spectral dispersive elements 106a-106p. Further, second through p^{th} plurality of wavelength sub-bands of light emitted by the second through p^{th} plurality of spectral dispersive elements 106b-106p, respectively may be provided to second through p^{th} contour dispersive arrays 108b-108p of the plurality of contour dispersive arrays 108, respectively.

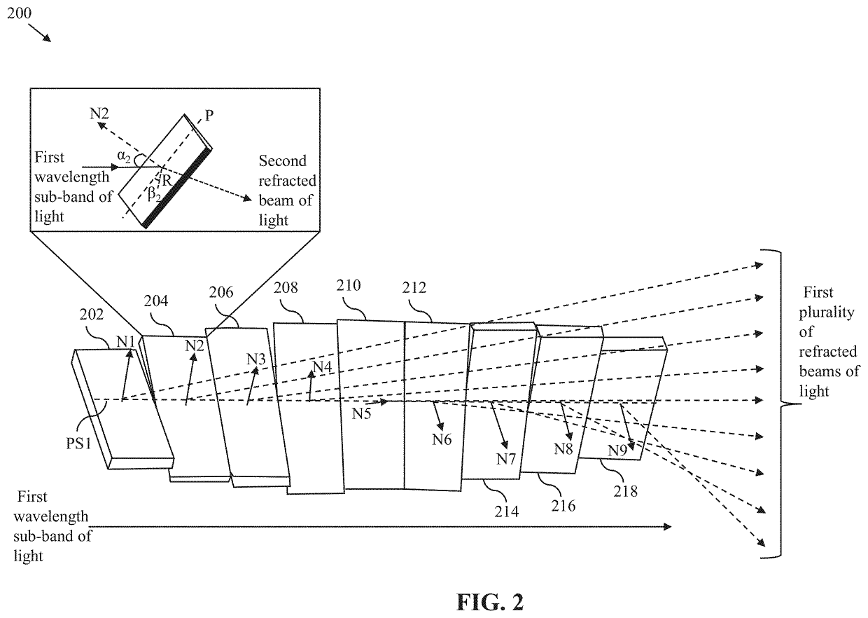

The plurality of contour dispersive arrays 108 may be coupled to the spectral dispersive array 106. The plurality of contour dispersive arrays 108 may be configured to receive the first through p^{th} plurality of wavelength sub-bands of light from the spectral dispersive array 106. The plurality of contour dispersive arrays comprises a first contour dispersive array 108a, a second contour dispersive array 108b, a third contour dispersive array 108c up to a p^{th} contour dispersive array 108p. Each contour dispersive array of the plurality of contour dispersive arrays 108 may include a plurality of contour dispersive elements. In an exemplary scenario, the first contour dispersive array 108a includes a first plurality of contour dispersive elements 110a-110m such as a first contour dispersive element 110a, a second contour dispersive element 110b, a third contour dispersive element 110c, a fourth contour dispersive element 110d, a fifth contour dispersive element 110e up to an m^{th} contour dispersive element 110m. The first plurality of contour dispersive elements 110a-110m may be configured to receive the first plurality of wavelength sub-bands of light such that the first contour dispersive element 110a receives the first wavelength sub-band of light, the second contour dispersive element 110b receives the second wavelength sub-band of light, and the m^{th} contour dispersive element 110m receives the m^{th} wavelength sub-band of light. Each contour dispersive element of the first plurality of contour dispersive elements 110a-110m may be configured to refract the received wavelength sub-band of light such that the first contour dispersive array 108a emits a first array of light beams to scan a desired target area. Each contour dispersive element of the first plurality of contour dispersive elements 110a-110m is explained in detail in conjunction with FIG. 2.

Each contour dispersive array of the plurality of contour dispersive arrays 108a-108p performs similar functions as performed by the first contour dispersive array 108a. Further, each contour dispersive array of the plurality of contour dispersive arrays 108a-108p is configured to scan a desired target area. Based on the desired target area to be scanned, the optical switch 104 directs and emits the beam of light from a corresponding output port to a corresponding spectral dispersive element. The corresponding spectral dispersive element emits a plurality of wavelength sub-bands of light such that a corresponding contour dispersive array receives the plurality of wavelength sub-bands of light and emits an array of light beams to scan a corresponding target area. Thus, the array of light beams may be steered to scan a desired target area by controlling the optical switch 104 by the control signal.

FIG. 2 is a diagram 200 that illustrates the first contour dispersive element 110a of the first plurality of contour dispersive elements 110a-110m, in accordance with an embodiment of the present disclosure. The first contour dispersive element 110a comprises a first plurality of contours 202-218 of which a first contour 202, a second contour 204, a third contour 206, a fourth contour 208, a fifth contour 210, a sixth contour 212, a seventh contour 214, an eight contour 216, and a ninth contour 218 are shown. Similarly, remaining contour dispersive elements of the first plurality of contour dispersive elements 110a-110m comprises a corresponding plurality of contours.

Each contour of the first plurality of contours 202-218 may be an optical glass and each contour has a corresponding pitch angle ‘α’ and a corresponding yaw angle ‘β’. The pitch angle α is an angle between the incident wavelength sub-band of light and a surface normal vector of the contour. The yaw angle ‘β’ is an angle between a vector perpendicular to the surface normal vector of the contour and a vector perpendicular to a refracted beam of light. The pitch angle ‘α’ and the yaw angle ‘β’ specify a position of the corresponding contour in a space. Each contour of the plurality of contours 202-218 has a surface normal vector. The first contour 202 has a first surface normal vector N1, the second contour 204 has a second surface normal vector N2, the third contour 206 has a third surface normal vector N3, the fourth contour 208 has a fourth surface normal vector N4, and the fifth contour 210 has a fifth surface normal vector N5. Further, the sixth contour 212 has a sixth surface normal vector N6, the seventh contour 214 has a seventh surface normal vector N7, the eighth contour 216 has an eighth surface normal vector N8, and the ninth contour 218 has a ninth surface normal vector N9. A vector PS1 that is perpendicular to the first surface normal vector N1 and a vector PS2 that is perpendicular to the second surface normal vector N2 are illustrated in FIG. 2. In an exemplary scenario, a first pitch angle ‘α₁’ is an angle between the first wavelength sub-band of light and the first surface normal vector N1, and a first yaw angle ‘β₂’ is an angle between the vector PS1 and a vector PR1 that is perpendicular to a first refracted beam of light. Further, a second pitch angle ‘α₂’ is an angle between the first wavelength sub-band of light and the second surface normal vector N2, and a second yaw angle ‘β₂’ is an angle between the vector P and a vector R that is perpendicular to a second refracted beam of light. When the first wavelength sub-band of light of the first plurality of wavelength sub-bands of light is incident on the first contour dispersive element 110a, each contour of the first plurality of contours 202-218 refracts the incident first wavelength sub-band of light at a unique angle (due to a unique pitch angle and a unique yaw angle that results in a unique refractive index) such that first plurality of refracted beams of light from the first contour dispersive element 110a are emitted. The first contour 202 refracts a first wavelength sub-band of light to emit the first refracted beam of light. Similarly, the second contour 204 refracts the first wavelength sub-band of light to emit the second refracted beam of light.

Each contour dispersive element of the first plurality of contour dispersive elements 110a-110m thus emits a corresponding plurality of refracted beams of light simultaneously. The refracted beams of light from each contour dispersive element thus form the first array of light beams.

Although FIG. 2 illustrates the first contour dispersive element 110a with nine contours, the scope of the present disclosure is not limited to it. In various other embodiments, the number of contours in the first contour dispersive element 110a may be more than or less than nine, without deviating from the scope of the present disclosure.

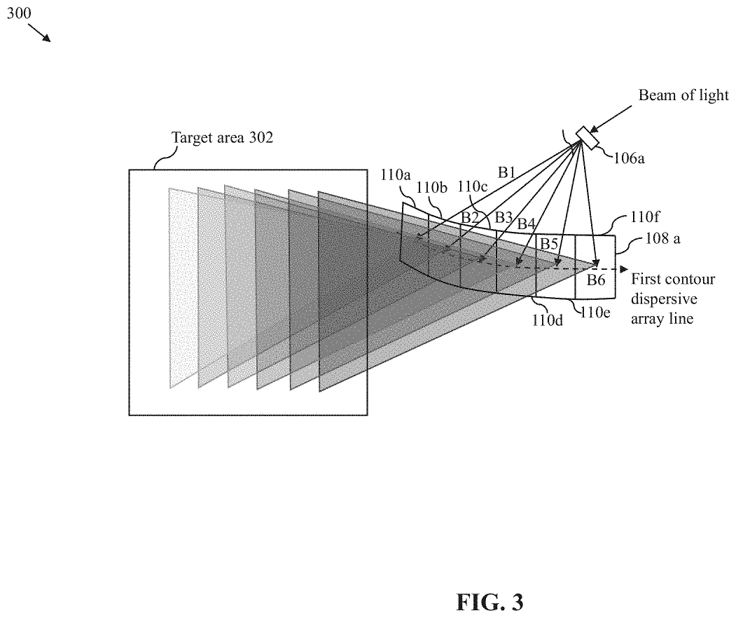

FIG. 3 is a diagram that illustrates a schematic view 300 of a dispersion of the beam of light by the first spectral dispersive element 106a and emission of the first array of light beams by the first contour dispersive array 108a to scan a first desired target area 302, in accordance with an embodiment of the present disclosure. The first contour dispersive array 108a comprises the first plurality of contour dispersive elements 110a-110m of which the first contour dispersive element 110a, the second contour dispersive element 110b, the third contour dispersive element 110c, the fourth contour dispersive element 110d, the fifth contour dispersive element 110e, and a sixth contour dispersive element 110f are shown in FIG. 3.

The first spectral dispersive element 106a receives the beam of light from the first output port P1 of the optical switch 104. The first spectral dispersive element 106a further disperses the beam of light into the first wavelength sub-band of light B1, the second wavelength sub-band of light B2, a third wavelength sub-band of light B3, a fourth wavelength sub-band of light B4, a fifth wavelength sub-band of light B5, and a sixth wavelength sub-band of light B6. The first contour dispersive element 110a, the second contour dispersive element 110b, the third contour dispersive element 110c, the fourth contour dispersive element 110d, the fifth contour dispersive element 110e, and the sixth contour dispersive element 110f receive the first through sixth wavelength sub-bands of light B1-B6, respectively. An optical path distance between the first spectral dispersive element 106a and the first contour dispersive array 108a is such that the optical path distance facilitates the incidence of a corresponding wavelength sub-band of light on a corresponding contour dispersive element. The optical path distance between the first spectral dispersive element 106a and the first contour dispersive array 108a further facilitates the incidence of the corresponding wavelength sub-band of light on a fixed line in the corresponding contour dispersive element. The fixed line refers to a vector perpendicular to the surface normal vector. The corresponding wavelength sub-band of light is incident on the fixed line of the corresponding contour dispersive element. The fixed line of the first contour dispersive element 110a, the second contour dispersive element 110b, the third contour dispersive element 110c, the fourth contour dispersive element 110d, the fifth contour dispersive element 110e, and the sixth contour dispersive element 110f are connected to form a first contour dispersive array line. In other words, the first contour dispersive array line connects each of the first contour dispersive element 110a, the second contour dispersive element 110b, the third contour dispersive element 110c, the fourth contour dispersive element 110d, the fifth contour dispersive element 110e, and the sixth contour dispersive element 110f. Each of the first contour dispersive element 110a, the second contour dispersive element 110b, the third contour dispersive element 110c, the fourth contour dispersive element 110d, the fifth contour dispersive element 110e, and the sixth contour dispersive element 110f are designed to refract a predetermined wavelength sub-band of light by a corresponding angle of refraction to scan the first desired target area 302 based on Snell's law. The first array of light beams scans the first desired target area 302 as depicted in FIG. 3.

The second through p^{th} contour dispersive arrays 108b-108p emit second through p^{th} array of light beams to scan corresponding desired target areas, respectively, in a similar manner as the first contour dispersive array 108a.

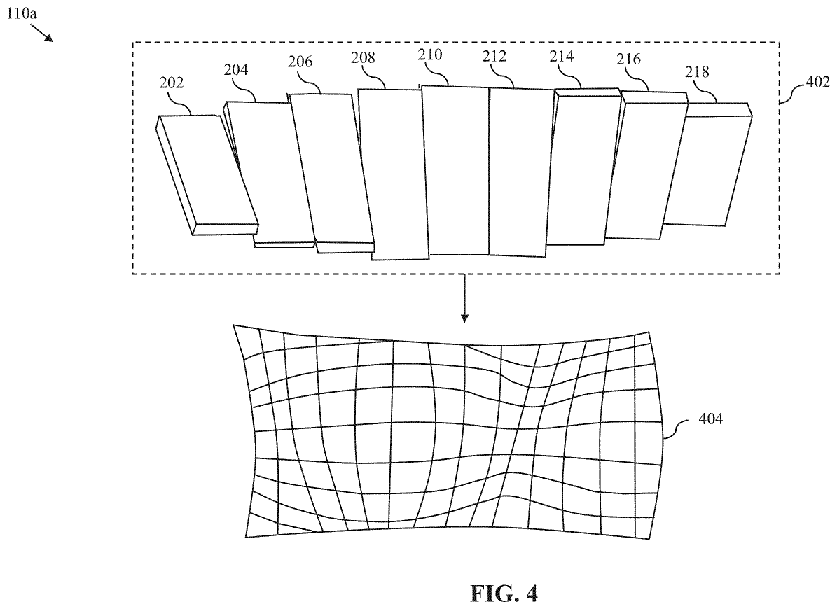

FIG. 4 is a diagram that illustrates a schematic view of the first contour dispersive element 110a in accordance with an embodiment of the present disclosure. FIG. 4 depicts a quasi-planar surface 402 and a first contoured surface 404 of the first contour dispersive element 110a. The first contoured surface 404 is a single contiguous planar surface. The quasi-planar surface 402 of the first contour dispersive element 110a may be converted into the first contoured surface 404 using a combination of various blending techniques, molding techniques, and smoothing techniques as will be apparent to a person skilled in the art. The first contoured surface 404 performs functions similar to the quasi-planar surface 402. Further, a size of the first contoured surface 404 is smaller in comparison to a size of the quasi-planar surface 402. Thus, when the first contoured surface 404 is included in the beam scanning system 100, such a beam scanning system 100 is compact as compared to the beam scanning system 100 having the quasi-planar surface 402.

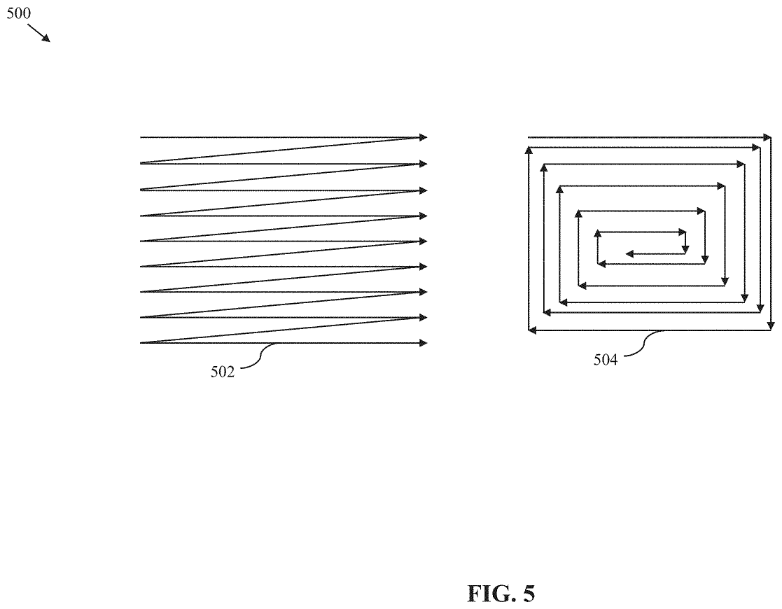

FIG. 5 is a diagram that illustrates a schematic view 500 of a raster scan pattern 502 and a clock-wise spiral scan pattern 504 formed by scanning a second desired target area (not shown) by the beam scanning system 100 of FIG. 1, in accordance with an embodiment of the present disclosure. The raster scan pattern 502 and the clock-wise spiral scan pattern 504 refer to a type of pattern in which the beam scanning system 100 scans the second desired target area. A scan pattern of the beam scanning system 100 depends on an arrangement of a plurality of contours. For a first arrangement of the plurality of contours at a corresponding pitch angle and a corresponding yaw angle, the beam scanning system 100 scans the second desired target area in a single scan pattern. In an exemplary scenario, the first contour element 110a comprises three contours, namely the first contour 202, the second contour 204, and the third contour 206. In an example, to attain the raster scan pattern 502, the first pitch angle α₁ and the first yaw angle β₁ of the first contour 202 is 30 degrees and 40 degrees, respectively, and the second pitch angle α₂ and the second yaw angle β₂ of the second contour 204 is 33 degrees and 37 degrees, respectively. Further, a third pitch angle α₃ and a third yaw angle β₃ of the third contour 206 is 27 degrees and 35 degrees, respectively. In another example, to attain the clock-wise spiral scan pattern 504, the first pitch angle α₁ and the first yaw angle β₁ of the first contour 202 is 40 degrees and 32 degrees, respectively, and the second pitch angle α₂ and the second yaw angle β₂ of the second contour 204 is 43 degrees and 27 degrees, respectively. Further, the third pitch angle α₃ and the third yaw angle β₃ of the third contour 206 is 47 degrees and 45 degrees, respectively. The scan pattern is varied by manipulating the arrangement of the plurality of contours by varying a pitch angle and a yaw angle of each contour of the plurality of contours.

Although FIG. 5 illustrates the raster scan pattern 502 and the clock-wise spiral scan pattern 504, the scope of the present disclosure is not limited to it. In various other embodiments, the beam scanning system 100 may scan the second desired target area using various scan patterns as will be apparent to a person skilled in the art, without deviating from the scope of the present disclosure.

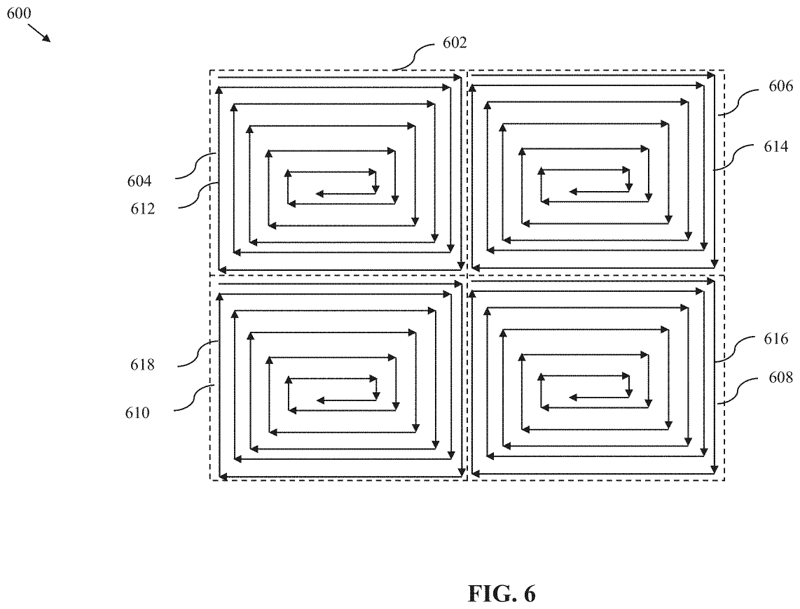

FIG. 6 is a diagram that illustrates a top view 600 of a third desired target area 602, in accordance with an embodiment of the present disclosure.

The third desired target area 602 is scanned by dividing the third desired target area 602 into a first sub-section 604, a second sub-section 606, a third sub-section 608, and a fourth sub-section 610. The beam of light emitted from the first output port P1 results in an emission of the first array of light beams that scans the first sub-section 604 in a first scan pattern 612. Further, the beam of light emitted from the second output port P2 results in an emission of the second array of light beams that scan the second sub-section 606 in a second scan pattern 614. Similarly, the third sub-section 608 and the fourth sub-section 610 are scanned in a third scan pattern 616 and a fourth scan pattern 618, respectively.

The third desired target area 602 may thus be divided into any number of sub-sections. The number of sub-sections of the third desired target area 602 may be randomly determined. Further, any contour dispersive array of the plurality of contour dispersive arrays 108a-108p may be configured to scan the sub-sections of the third desired target area 602 by the emission of corresponding array of light beams by a corresponding contour dispersive array of the plurality of contour dispersive arrays 108a-108p, without deviating from the scope of the present disclosure.

Although FIG. 6 illustrates that the first scan pattern 614, the second scan pattern 614, the third scan pattern 616, and the fourth scan pattern 618 are clock-wise spiral scan pattern 504, the scope of the present disclosure is not limited to it. In various other embodiments, the first scan pattern 614, the second scan pattern 614, the third scan pattern 616 and the fourth scan pattern 618 may be any scan pattern of various scan patterns as will be apparent to a person skilled in the art, without deviating from the scope of the present disclosure.

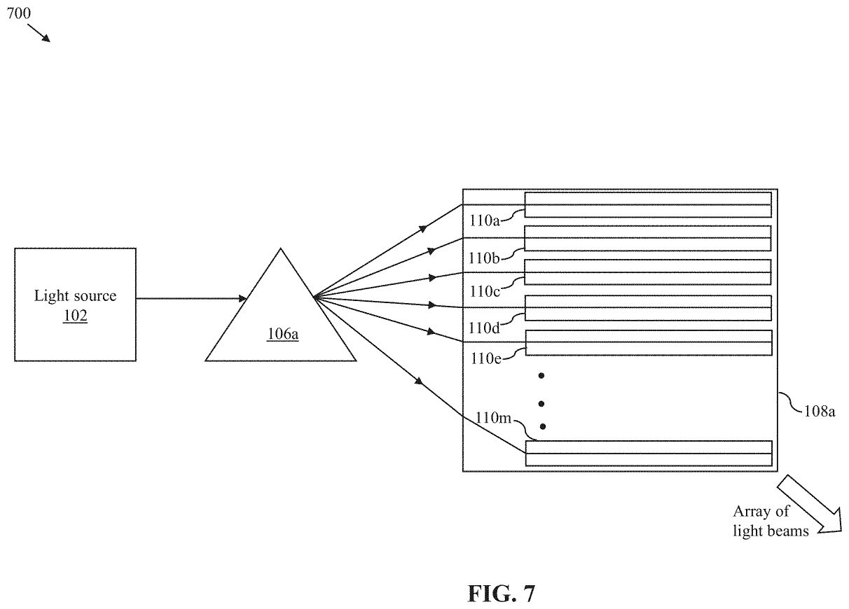

FIG. 7 is a diagram that illustrates a schematic view of a beam scanning system 100, in accordance with another embodiment of the present disclosure. The beam scanning system 100 may include the light source 102, the first spectral dispersive element 106a, and the first contour dispersive array 108a.

The light source 102 may be configured to emit the beam of light. The first spectral dispersive element 106a may be coupled to the light source 102. The first spectral dispersive element 106a may be configured to receive the beam of light. The first spectral dispersive element 106a further disperses the beam of light into the first plurality of wavelength sub-bands of light. The first contour dispersive array 108a may be coupled to the first spectral dispersive element 106a. The first contour dispersive array 108a may be configured to receive the first plurality of wavelength sub-bands of light. The first contour dispersive array 108a includes the first plurality of contour dispersive elements 110a-110m. The first plurality of contour dispersive elements 110a-110m may be configured to receive the first plurality of wavelength sub-bands of light such that the first contour dispersive element 110a receives the first wavelength sub-band of light, the second contour dispersive element 110b receives the second wavelength sub-band of light, and the m^{th} contour dispersive element 110m receives the m^{th} wavelength sub-band of light. Each contour dispersive element of the first plurality of contour dispersive elements 110a-110m may be configured to refract the received wavelength sub-band of light such that the first contour dispersive array 108a emits the array of light beams to scan the desired target area.

The desired target area scanned by the beam scanning system 100 of FIG. 7 is smaller than the desired target area scanned by the beam scanning system 100 of FIG. 1, as the beam scanning system 100 of FIG. 7 does not include the optical switch 104, the second through th p spectral dispersive elements 106b-106p, and the second through p^{th} contour dispersive arrays 108b-108p.

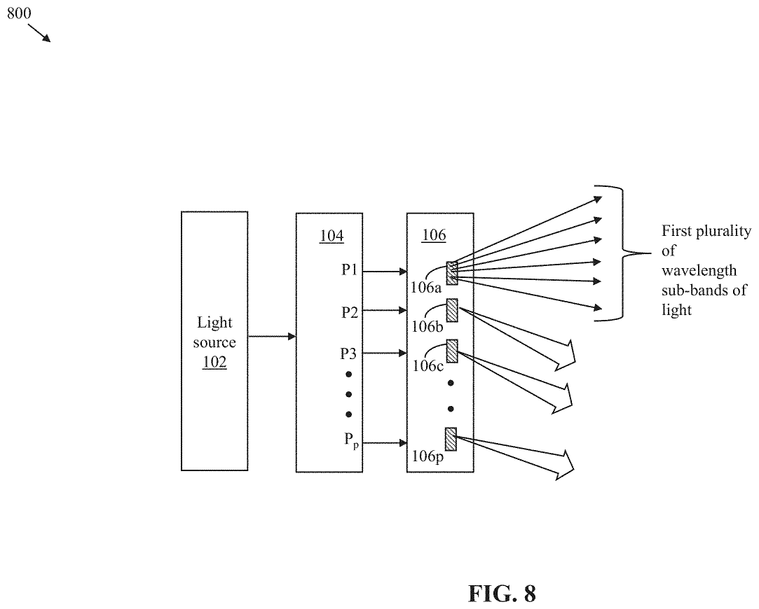

FIG. 8 is a diagram that illustrates a schematic view of a beam scanning system 100 in accordance with yet another embodiment of the present disclosure. The beam scanning system 100 may include the light source 102, the optical switch 104, and the spectral dispersive array 106.

The light source 102 may be configured to emit the beam of light. The beam of light emitted by the light source 102 may be provided to the optical switch 104. The optical switch 104 may be coupled to the light source 102. Further, the optical switch 104 may be configured to receive the beam of light from the light source 102. The optical switch 104 has the plurality of output ports P1-Pp. The optical switch 104 may be further configured to receive the control signal from the external controller (not shown) and select an output port from the plurality of output ports P1-Pp based on the received control signal. The optical switch 104 may be further configured to direct the received beam of light from the light source 102 to the selected output port and emit the beam of light from the selected output port of the plurality of output ports P1-Pp. The spectral dispersive array 106 may be coupled to the optical switch 104. The spectral dispersive array 106 may be configured to receive the beam of light from the corresponding output port of the optical switch 104. The spectral dispersive array 106 comprises the plurality of spectral dispersive elements 106a-106p. Each spectral dispersive element of the plurality of spectral dispersive elements 106a-106p is parallelly connected to a corresponding output port of the plurality of output ports P1-Pp. Thus, the first spectral dispersive element 106a may be parallelly connected to the first output port P1. Further, the first spectral dispersive element 106a may be configured to receive the beam of light from the first output port P1. The first spectral dispersive element 106a may be further configured to refract different wavelengths present in the beam of light (i.e., the full wavelength spectrum of light) at different angles which results in the dispersion of the beam of light into a first plurality of wavelength sub-bands of light that scans a desired target area.

The desired target area scanned by the beam scanning system 100 of FIG. 8 is smaller than the desired target area scanned by the beam scanning system 100 of FIG. 1, as the beam scanning system 100 of FIG. 8 does not include the plurality of contour dispersive arrays 108. The desired target area scanned by the beam scanning system 100 of FIG. 8 may be similar to the desired target area scanned by the beam scanning system 100 of FIG. 7 if the number of wavelength sub-bands of light emitted by the spectral dispersive array 106 is equal to a number of light beams in the array of light beams emitted by the first contour dispersive array 108a.

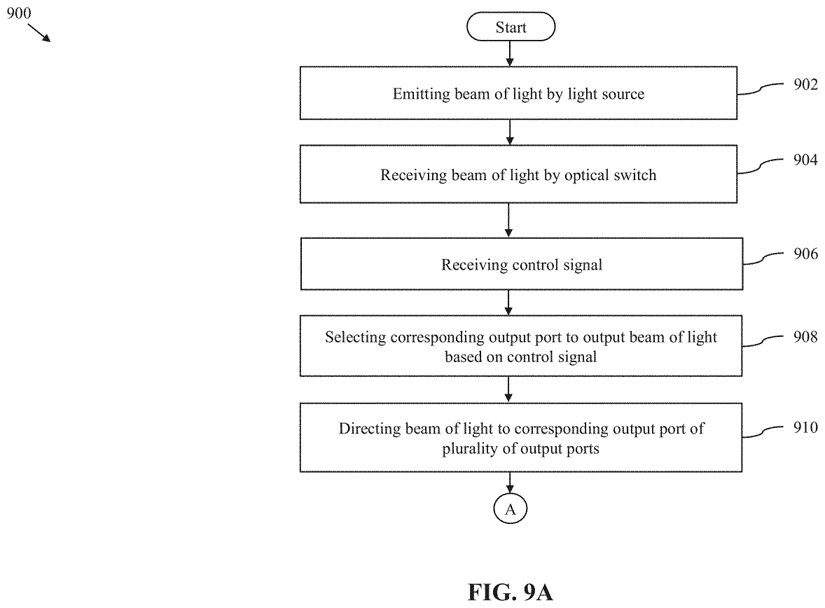

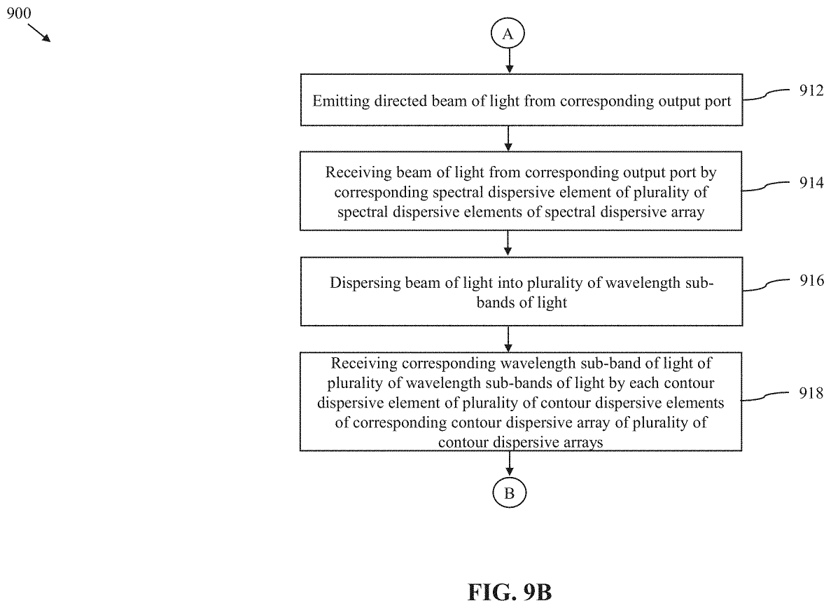

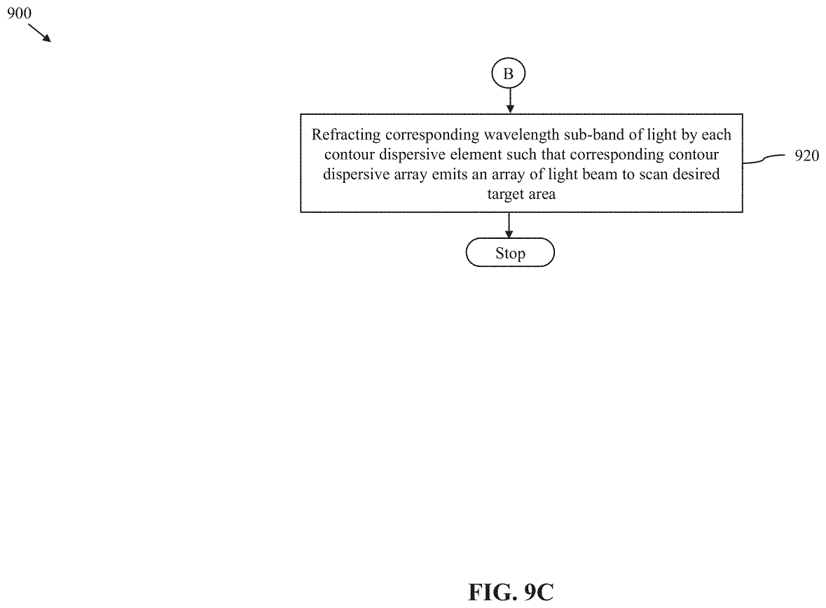

FIGS. 9A, 9B, and 9C is a flowchart 900 that collectively illustrates a beam scanning method of the beam scanning system 100 of FIG. 1, in accordance with an embodiment of the present disclosure. At 902, the light source 102 emits the beam of light. At 904, the optical switch 104 receives the beam of light emitted by the light source 102. At 906, the optical switch 104 receives the control signal from the external controller. At 908, the optical switch 104 selects the corresponding output port of the plurality of output ports P1-Pp to output the beam of light based on the control signal. At 910, the optical switch 104 directs the beam of light to the corresponding output port of the plurality of output ports P1-Pp that is selected based on the control signal. At 912, the optical switch 104 emits the directed beam of light from the corresponding output port of the plurality of output ports P1-Pp. At 914, the corresponding spectral dispersive element of the plurality of spectral dispersive elements 106a-106p of the spectral dispersive array 106 receives the beam of light from the corresponding output port of the plurality of output ports P1-Pp. At 916, the corresponding spectral dispersive element disperses the beam of light into the plurality of wavelength sub-bands of light. At 918, the corresponding contour dispersive element of the plurality of contour dispersive elements of the corresponding contour dispersive array of the plurality of contour dispersive arrays 108a-108p receives the corresponding wavelength sub-band of light of the plurality of wavelength sub-bands of light. At 920, each contour dispersive element of the plurality of contour dispersive elements refracts the corresponding wavelength sub-band of light such that the corresponding contour dispersive array emits the array of light beams to scan the desired target area.

The beam scanning system 100 is a solid-state system that is free of moving parts and thus, is not prone to reliability issues and vibration effects in comparison to beam scanning systems that are realized using mechanical components. The beam scanning system 100 is compact as compared to conventional beam scanning systems that are realized using mechanical components. The beam scanning system 100 is of a smaller size in comparison to the size of conventional beam scanning systems that are realized using mechanical components. Further, the beam scanning system 100 utilizes a low power light source as the beam scanning system 100 does not employ a power splitter. Thus, low optical loss is exhibited by the beam scanning system 100 in comparison to other conventional solid-state beam scanning systems that utilize high-power light sources. The beam scanning system 100 of FIG. 1 may be utilized in LIDAR systems for land surveying, providing self-driving instructions for autonomous vehicles, inspecting power lines for maintenance, and scanning forests and agricultural lands.

Coupling as mentioned in this disclosure refers to an optical coupling, a mechanical coupling, an electrical coupling, an electromagnetic coupling, or a combination thereof.

In the claims, the words ‘comprising’, ‘including’, and ‘having’ do not exclude the presence of other elements or steps than those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various exemplary embodiments of the disclosed system and method have been described above, it should be understood that they have been presented for purposes of example only, not limitations. It is not exhaustive and does not limit the disclosure to the precise form disclosed. Numerous modifications, changes, variations, substitutions, and equivalents will be apparent to those skilled in the art, without departing from the spirit and scope of the present disclosure, as described.

1. A beam scanning system comprising:
a light source configured to emit a beam of light;
an optical switch that is coupled to the light source and has a plurality of output ports, wherein the optical switch is configured to receive the beam of light, direct the beam of light to a first output port of the plurality of output ports, and emit the beam of light from the first output port;
a spectral dispersive array comprising a plurality of spectral dispersive elements, wherein each spectral dispersive element of the plurality of spectral dispersive elements is coupled to a corresponding output port of the plurality of output ports, and wherein a first spectral dispersive element of the plurality of spectral dispersive elements is configured to receive the beam of light from the first output port of the optical switch and disperse the beam of light into a plurality of wavelength sub-bands of light; and
a plurality of contour dispersive arrays, wherein each contour dispersive array of the plurality of contour dispersive arrays is associated with a corresponding spectral dispersive element of the spectral dispersive array, wherein a first contour dispersive array of the plurality of contour dispersive arrays comprises a plurality of contour dispersive elements, wherein each contour dispersive element of the plurality of contour dispersive elements is configured to receive and refract a corresponding wavelength sub-band of light of the plurality of wavelength sub-bands of light such that the first contour dispersive array emits an array of light beams to scan a desired target area.

2. The beam scanning system of claim 1, wherein the light source is a wavelength-tunable light source.

3. The beam scanning system of claim 1, wherein the optical switch is further configured to receive a control signal and select the first output port to output the beam of light based on the control signal.

4. The beam scanning system of claim 1, wherein the beam of light emitted by the light source is a full wavelength spectrum.

5. The beam scanning system of claim 1, wherein a number of output ports in the optical switch is equal to a number of spectral dispersive elements in the spectral dispersive array and a number of contour dispersive arrays of the plurality of contour dispersive arrays.

6. The beam scanning system of claim 1, wherein a number of wavelength sub-bands of light of the plurality of wavelength sub-bands of light is equal to a number of contour dispersive elements in a contour dispersive array of the plurality of contour dispersive arrays.

7. The beam scanning system of claim 1, wherein each contour dispersive element of the plurality of contour dispersive elements comprises a plurality of contours such that each contour of the plurality of contours has a corresponding yaw angle and a corresponding pitch angle.

8. The beam scanning system of claim 7, wherein each contour of the plurality of contours provides a corresponding angle of refraction to the wavelength sub-band of light simultaneously such that each contour dispersive element of the plurality of contour dispersive elements simultaneously emits corresponding plurality of refracted beams of light, and wherein the array of light beams includes the corresponding plurality of refracted beams of light emitted from each contour dispersive element.

9. The beam scanning system of claim 1, wherein the plurality of wavelength sub-bands of light are contiguous wavelength sub-bands of light.

10. The beam scanning system of claim 1, wherein the beam of light is dispersed based on an optical path distance between the spectral dispersive array and the plurality of contour dispersive arrays.

11. The beam scanning system of claim 1, wherein the optical switch may be a free space optical switch, a fiber optic switch, a silicon-photonics based optical switch, a group III-V based optical switch, and wherein the optical switch further includes a gain element.

12. A beam scanning system comprising:
a light source configured to emit a beam of light;
a spectral dispersive element coupled to the light source, wherein the spectral dispersive element is configured to receive the beam of light and disperse the beam of light into a plurality of wavelength sub-bands of light; and
a contour dispersive array coupled to the spectral dispersive element, wherein the contour dispersive array comprises a plurality of contour dispersive elements, wherein each contour dispersive element of the plurality of contour dispersive elements is configured to receive and refract a corresponding wavelength sub-band of light of the plurality of wavelength sub-bands of light such that the contour dispersive array emits an array of light beams to scan a desired target area.

13. The beam scanning system of claim 12, wherein the light source is a wavelength-tunable light source, and wherein the beam of light emitted by the light source is a full wavelength spectrum.

14. The beam scanning system of claim 12, wherein a total number of wavelength sub-bands of light of the plurality of wavelength sub-bands of light is equal to a total number of contour dispersive elements in the contour dispersive array.

15. The beam scanning system of claim 12, wherein each contour dispersive element of the plurality of contour dispersive elements comprises a plurality of contours such that each contour of the plurality of contours has a corresponding yaw angle and a corresponding pitch angle.

16. The beam scanning system of claim 15, wherein each contour of the plurality of contours provides a corresponding angle of refraction to the received wavelength sub-band of light simultaneously such that each contour dispersive element of the plurality of contour dispersive elements simultaneously emits corresponding plurality of refracted beam of light, and wherein the array of light beams includes the corresponding plurality of refracted beams of light emitted from each contour dispersive element.

17. The beam scanning system of claim 12, wherein the beam of light is dispersed based on an optical path distance between the spectral dispersive element and the contour dispersive array.

18. A beam scanning system comprising:
a light source configured to emit a beam of light;
an optical switch coupled to the light source, wherein the optical switch includes a plurality of output ports, and configured to receive the beam of light, direct the beam of light to a first output port of the plurality of output ports, and emit the beam of light from the corresponding output port; and
a spectral dispersive array comprising a plurality of spectral dispersive elements, wherein each spectral dispersive element of the plurality of spectral dispersive elements is coupled to a corresponding output port of the plurality of output ports, and wherein a first spectral dispersive element of the plurality of spectral dispersive elements is configured to receive the beam of light from the first output port of the optical switch and disperse the beam of light into a plurality of wavelength sub-bands of light to scan a desired target area.

19. The beam scanning system of claim 18, wherein the light source is a wavelength-tunable light source, and wherein the beam of light emitted by the light source is a full wavelength spectrum.

20. The beam scanning system of claim 18, wherein the optical switch is further configured to receive a control signal and select the first output port to output the beam of light based on the control signal, and wherein a total number of output ports in the optical switch is equal to a total number of spectral dispersive elements in the spectral dispersive array.
